(19) United States
(12) Patent Application Publication
(10) Pub. No.: US 2008/0313601 A1
(43) Pub. Date: Dec. 18, 2008

(54) Speech IC Simulation Method, System and Medium thereof

(76) Inventors: Ting-li Huang, Jhubei City (TW); Shih-Peng Huang, Sinfong Township (TW); Wae-Jone Hao, Jhongli City (TW); Cheng-Wei Lin, Toufen Township (TW)

Correspondence Address: HDSL, P.O. BOX 220746, CHANTILLY, VA, 20153-0746, US

(21) Appl. No.: 12/054,637

(22) Filed: Mar. 25, 2008

(30) Foreign Application Priority Data
Jun. 14, 2007 (TW) 096121445

(51) Int. Cl. G06F 9/44

(52) U.S. Cl. 717/105; 717/109

(57) ABSTRACT

In a speech IC simulation method, a system, a medium and a firmware code generation method, the speech IC simulation method for obtaining a simulation result of a speech IC project includes the steps of establishing and compiling a speech IC project in a wizard interface, setting and displaying a visualized in-circuit emulator (ICE) allocation interactively corresponding to the speech IC project in a visualized allocation interface, and setting and performing the clips and corresponsive system trigger events in a visualized clip editing and event setting interface if a modification of the speech IC project is required. Moreover, the firmware code from compiling the speech IC project may be outputted through an output port such as an USB port or a printer port or recorded in a memory of a circuit emulator.

### BACKGROUND

The present invention relates to a speech IC simulation method, a system and a medium, and more specifically, to the method and system performing speech IC simulation and verification in a visualized development system of speech IC.

Lots of tools for integrated circuit design and verification have provided to research and development engineers so far. For instance, the common way for the engineers to construct their clips corresponding to the events of speech IC and set the system configuration during application program execution is line by line editing using the directives and instructions of a specific programming language in a command line interface presently.

However, the mentioned editing environment is not user-friendly and efficient since it lacks of a visualized or graphic interface. In general, it increases the costs in typing word by word and fixing the typing error, and hence the reusability and scalability of code generation and migration to customer for testing.

### BRIEF SUMMARY

It is therefore a primary objective of the present invention to provide a speech IC simulation method including the steps of establishing and compiling a speech IC project in a wizard interface, setting and displaying a visualized in-circuit emulator (ICE) allocation interactively corresponding to the speech IC project modified in a visualized allocation interface, and setting and performing a clip and a corresponsive system trigger event in a visualized clip editing and event setting interface.

It is therefore a secondary objective of the present invention to provide a firmware code generation method of speech IC establishing and compiling a speech IC project in a wizard interface for generating a firmware code of speech IC. A modification of the speech IC project further performs the steps of setting and displaying a visualized in-circuit emulator allocation interactively corresponding to the speech IC project in a visualized allocation interface, and setting and performing a clip and a corresponsive system trigger event at least in a visualized clip editing and event setting interface.

Yet it is therefore a secondary objective of the present invention to provide a computer readable medium storing a visualized development system of speech IC including a wizard interface for establishing a speech IC project, a visualized allocation interface for setting and displaying a visualized in-circuit emulator allocation interactively corresponding to the speech IC project, and a visualized clip editing and event setting interface for setting and performing a clip and a corresponsive system trigger event.

Yet it is therefore a secondary objective of the present invention to provide a speech IC simulation system including a visualized development system of speech IC for generating a firmware code corresponding to a speech IC project, and a circuit emulator for receiving the firmware code outputted through an output port such as a printer port and an USB port and emulating the speech IC project.

Yet it is therefore a secondary objective of the present invention to provide a speech IC simulation system including a visualized development system of speech IC for establishing a speech IC project and setting and performing a clip and a system trigger event, and a product icon corresponding to the speech IC project for displaying a simulation result according to the performing of the clip and the system trigger event.

Accordingly, the claimed speech IC simulation method, system, medium and firmware code generation method may lowered the learning threshold and reduce the system development period and the loading in debugging.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flowchart of the speech IC simulation method according to the present invention.

FIG. 2A is a flowchart of the firmware code generation method of speech IC according to the present invention.

FIG. 2B is flowchart of the steps of operating the wizard interface according to the present invention.

FIG. 3A is a diagram of the wizard interface of the medium according to one embodiment of the present invention.

FIG. 3B is a diagram of the wizard interface of the medium according to another embodiment of the present invention.

FIG. 3C is a diagram of the visualized allocation interface of the medium according to one embodiment of the present invention.

FIG. 3D is a diagram of the visualized in-circuit emulator allocation adjusted not yet of the medium according to one embodiment of the present invention.

FIG. 3E is a diagram of the visualized in-circuit emulator allocation adjusted of the medium according to one embodiment of the present invention.

FIG. 3F is a diagram of visualized clip editing and event setting interface of the medium according to one embodiment of the present invention.

FIG. 4 is a diagram of speech IC simulation system according to one embodiment of the present invention.

FIG. 5 is a diagram of speech IC simulation system according to another embodiment of the present invention.

### DETAILED DESCRIPTION

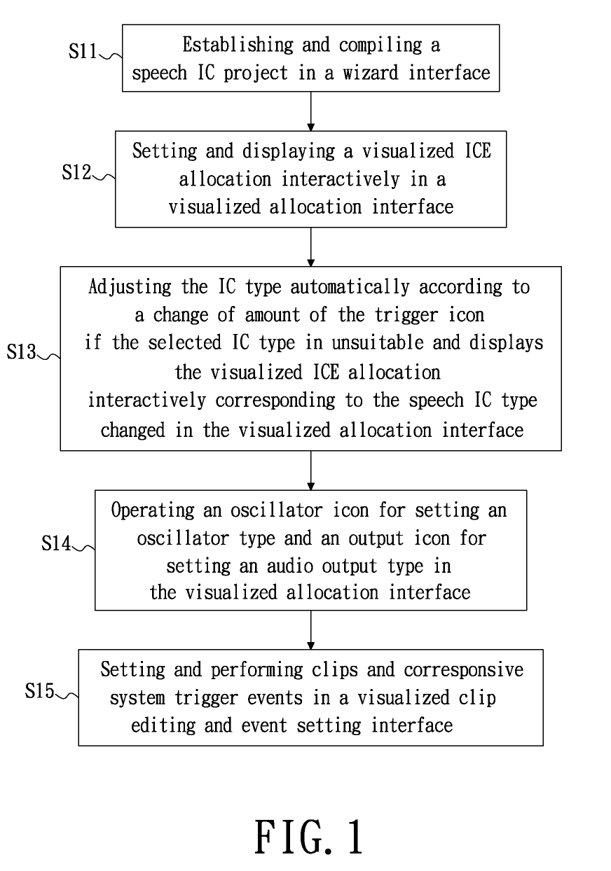

With referring to FIG. 1, the present speech IC simulation method establishes and compiles a speech IC project in a wizard interface in step S11, and it further includes the steps of selecting a project type to be generated, an IC type, amount of a trigger icon and a infrared transmission status, a pin matrix, a function are preset as triggers and as outputs otherwise and a signal type of each port and pin and an audio file, editing a clip for adding the function and instruction to be performed, setting a received data table and a corresponsive trigger type of each trigger and selecting a finish item to show related information of the speech IC project and an end item for compiling the speech IC project. In the embodiment, the project type to be generated is either a trigger and play project or an empty project, and the IC type is either a single channel IC or a multiple channel IC.

Moreover, the present speech IC simulation method sets and displays a visualized in-circuit emulator allocation interactively corresponding to the speech IC project modified in a visualized allocation interface in step S12, and it further includes the step of setting amount of a trigger icon of a visualized trigger pad and a function of each trigger icon in the visualized allocation interface, and setting an amount of input/output port, a function of input/output port, an output pin and a memory status of the visualized system allocation. After that, the method adjusts the IC type automatically according to a change of amount of the trigger icon if the selected IC type in unsuitable and displays the visualized in-circuit emulator allocation interactively corresponding to the speech IC type changed in the visualized allocation interface in step S13. Furthermore, it operates an oscillator icon for setting an oscillator type and an output icon for setting an audio output type such as PWM and DAC in the visualized allocation interface in step S14, and sets and performs clips and corresponsive system trigger events in a visualized clip editing and event setting interface in step S15. It's noted that the visualized clip editing and event setting interface provides a multiple channel play icon for setting an audio type to be played simultaneously if the multiple channel IC is selected.

Accordingly to the mentioned descriptions, the wizard interface guided the beginner or user unfamiliar with the system to establish a project step by step and smoothly, the visualized allocation interface capable of real time interaction through a graphic user interface (GUI) and maybe the dialog boxes provides the user an intuitive way to set and preview the allocation, and the visualized clip editing and event setting interface consists of a command editing window providing an interactive and visualized editing by dragging, placing and clicking to pop up a dialog box for setting the clips, and a event editing window for user to link the clips and system trigger events such as pressing a button or receiving a value through infrared. In addition, user may switch to the wizard interface for project modification during he/she is operating in the visualized allocation interface or the visualized clip editing and event setting interface.

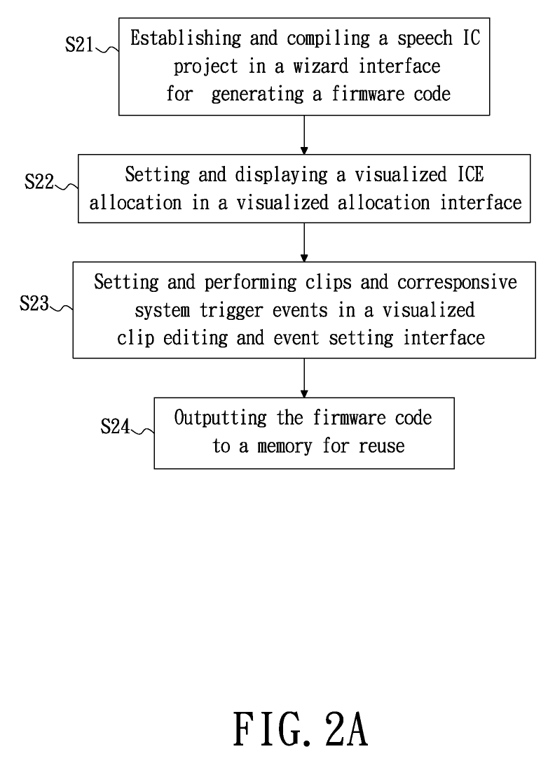

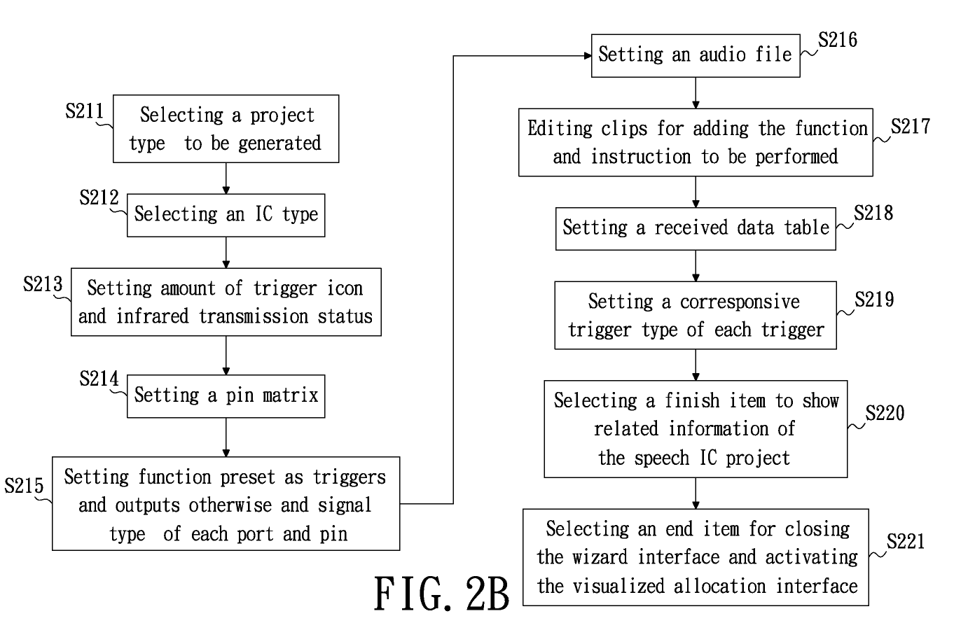

With referring to FIG. 2A, the present firmware code generation method of speech IC establishes and compiles a speech IC project in a wizard interface for generating a firmware code of speech IC in step S21, sets and displays a visualized in-circuit emulator allocation interactively corresponding to the speech IC project in a visualized allocation interface in step S23, sets and performs clips and corresponsive system trigger events in a visualized clip editing and event setting interface in step S23, and outputs the firmware code of speech IC to a memory such as a read only memory (ROM) or re-writable memory for reuse in step S24.

With referring to FIG. 2B, the details of operating the wizard interface are described here. It selects a project type to be generated and an IC type in step S211 and S212 respectively, sets amount of trigger icon and infrared transmission status, a pin matrix, function preset as triggers and outputs otherwise and signal type of each port and pin, an audio file in step S213, S214, S215 and S216 respectively, edits clips for adding the function and instruction to be performed in step S217, sets a received data table and a corresponsive trigger type of each trigger in step S218 and S219 respectively, and selects a finish item to show related information of the speech IC project and an end item for closing the wizard interface and activating the visualized allocation interface in step S220 and S221 respectively.

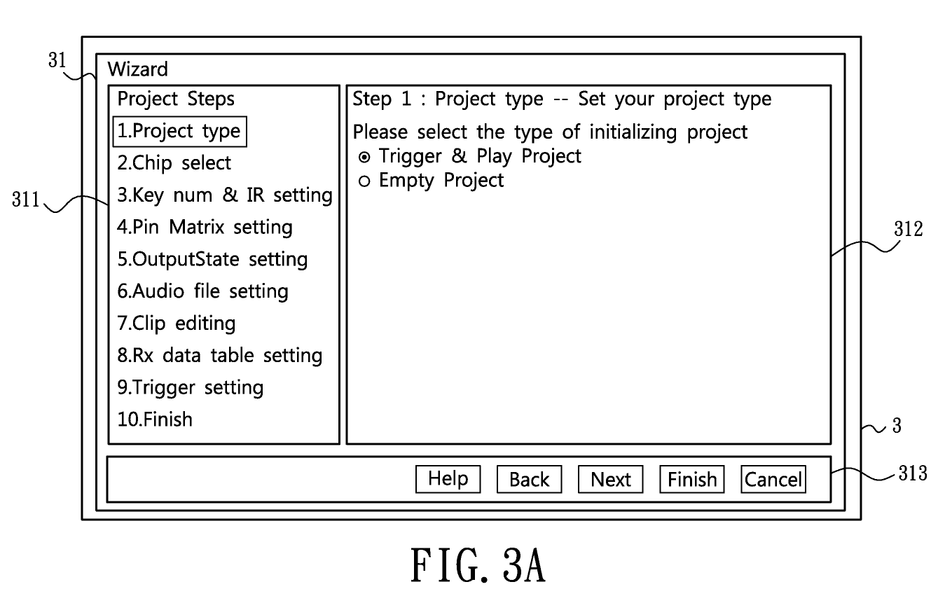

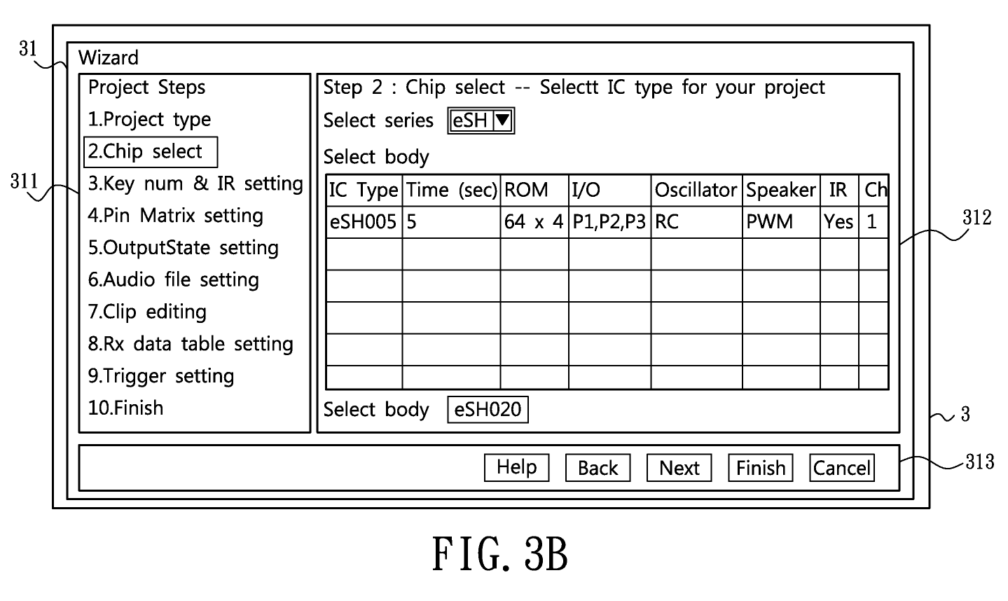

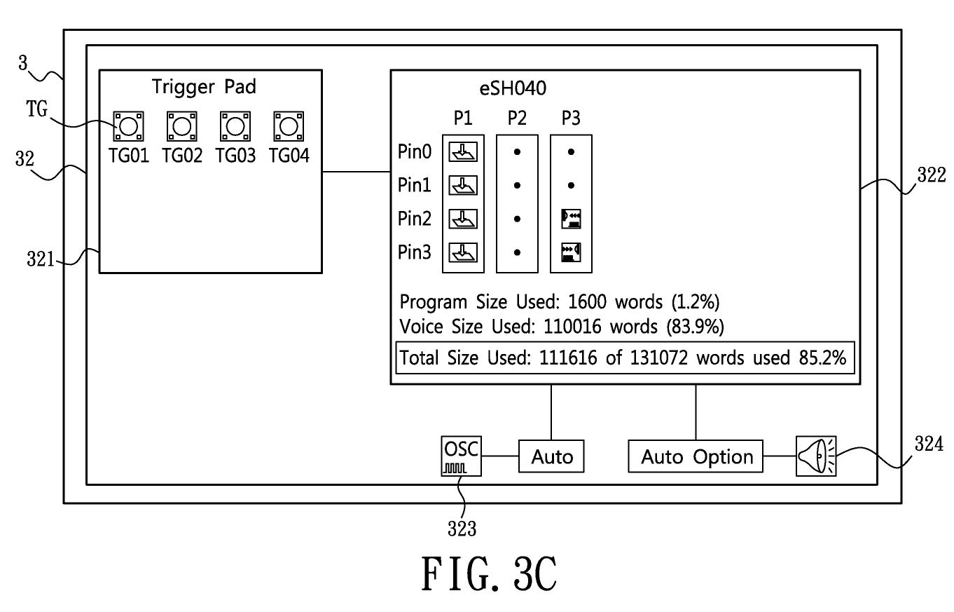

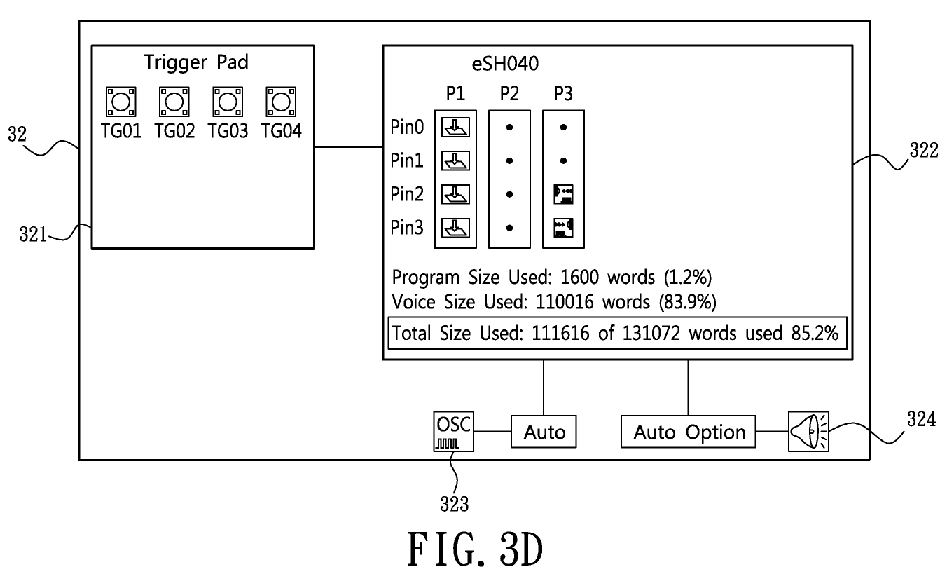

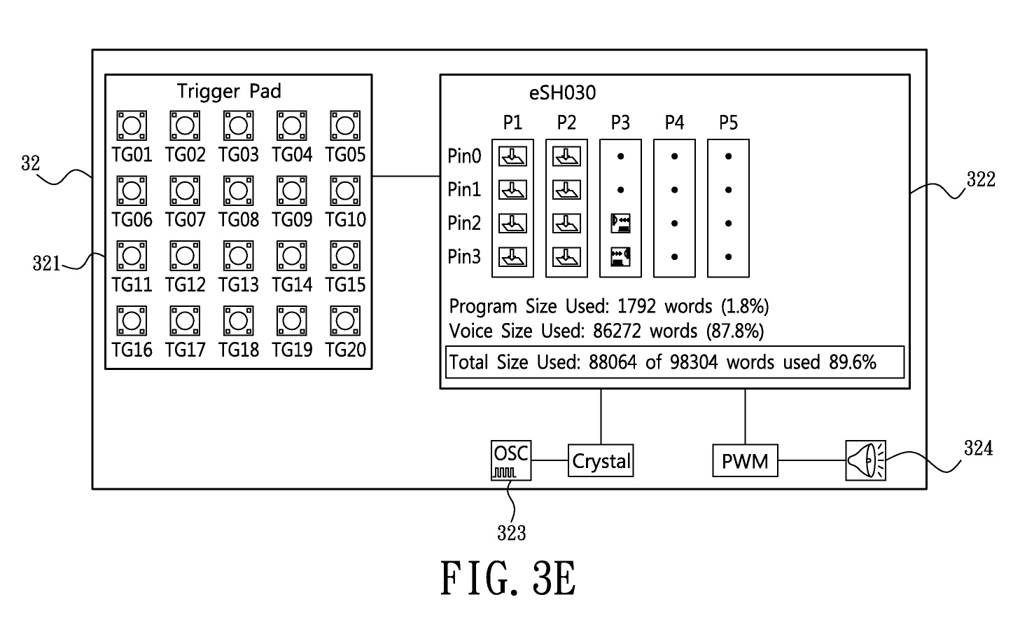

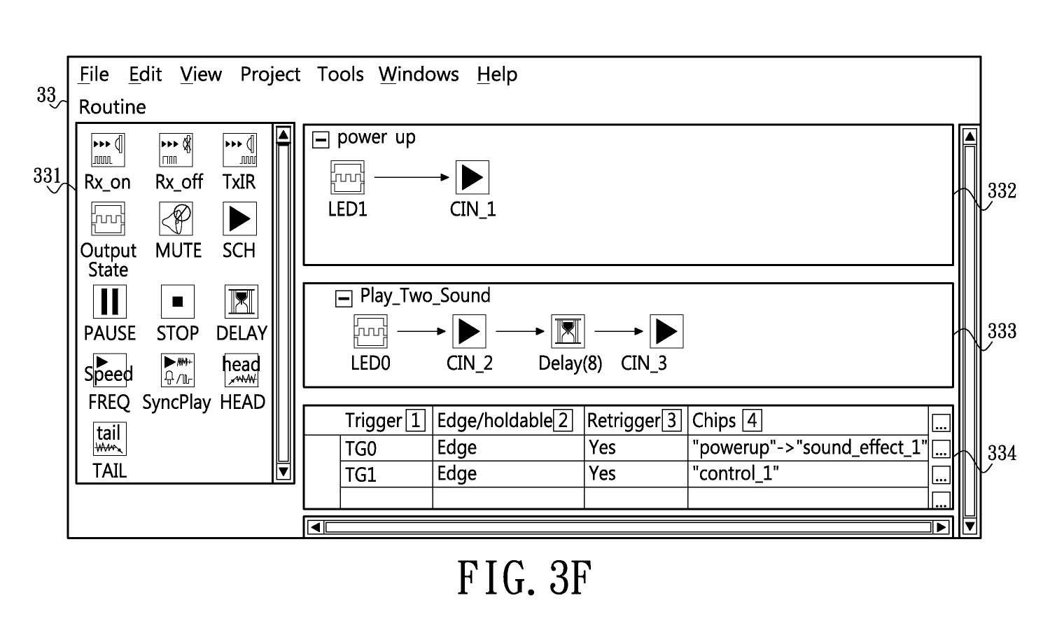

With referring to FIG. 3A to 3C, visualized development system of speech IC 3 have a wizard interface 31 with a project establishing step selection window 311, an advanced selection window 312 and a control trigger window 313 for establishing a speech IC project, a visualized allocation interface 32 for setting and displaying a visualized in-circuit emulator allocation interactively corresponding to the speech IC project and a visualized clip editing and event setting interface 33 for setting and performing clips and a corresponsive system trigger events. Hence, the project establishing step selection window 311 have the step items for selecting a project type to be generated, an IC type and a finish item to show related information of the speech IC project, setting amount of trigger icon and an infrared transmission status, a pin matrix, a function preset as triggers and outputs otherwise and a signal type of each port and pin, an audio file, a received data table and a corresponsive trigger type of each trigger, and editing clips for adding the function and instruction to be performed. The advanced selection window 312 shows the usable advanced item corresponding to the step selected in the project establishing step selection window 311, and the control trigger window 313 have the items of back, next, cancel, help and end. For instance, once the step of project type to be generated in the project establishing step selection window 311 is selected, the advanced selection window 312 shows the usable advanced item such as a trigger and play project for controlling audio play and pause by trigger and an empty project. Again, with referring to the FIG. 3B, once the step of IC type in the project establishing step selection window 311 is selected, the advanced selection window 312 shows the usable advanced item indicating a single channel IC and a multiple channel IC. Besides, the selection of an end item of the control trigger window 313 indicates the start of the compiling the selected speech IC project.

Again, with referring to FIG. 3C, the visualized in-circuit emulator allocation 32 shows a visualized trigger pad 321 displaying trigger icons TG 0 to N and a visualized system allocation 322 for setting amount and function of input/output port, assigning output pin and indicating memory status of the visualized system allocation. The visualized trigger pad 321 and the visualized system allocation 322 link each other in a wire to show the physical connection in bus. Hence, the dialog boxes will be popped up once the visualized allocation interface 32 is operated for allocation using a pointing device such as a mouse device. For example, a dialog box for setting the amount of the trigger icon is popped up after double clicking the visualized trigger pad 321, and then another dialog box for setting corresponsive function to be executed of a trigger icon TG is popped up when double clicking the trigger icon TG such as TG 01. In addition, the visualized allocation interface 32 sets the amount and function of input/output port, output pin and memory status, and further includes an oscillator icon 323 for setting an oscillator type such as RC, auto and crystal and an output icon 324 for setting an audio output type such as PWM, DAC and auto option with corresponsive dialog boxes through double clicking. Thus user can realize the adjustment and modification real time through the interactive visualized interface.

The embodiment in FIGS. 3D and 3E indicates that the content change of the visualized in-circuit emulator allocation 32. The amount of the trigger icons displayed in the visualized trigger pad 321 is changed from 4 to 20 since the IC type is changed from eSH040 to eSH030 according to an auto adjustment of the IC type of the visualized in-circuit emulator allocation 32. In addition, there are two extra input/output ports P4 and P5 of the eSH030 speech IC then, P2 has a function of trigger scan, oscillator type is adjusted from auto to crystal and audio output type is adjusted from auto option to PWM according to the specification of the eSH030 speech IC.

With referring to FIG. 3F, the visualized clip editing and event setting interface 33 generates the firmware code finally have an icon toolbox window 331 with many function icons for selecting, clip setting window 332 and 333 for forming and organizing the selected function icons into clip 1 and clip 2 to be performed by dragging, changing sequence and double clicking to pop up the corresponsive dialog boxes and an event setting window 324 for setting the system trigger events. Herein, the clips and the system trigger events are capable of linkage and adjustment interactively, and the system trigger event drives the clip to be performed of the trigger icon TG. The system trigger event may be classified into a trigger event and an infrared receiving. For instance, the trigger event of the TG 01 representing the physical button 1 indicates the playing of that of a WAV file or a MIDI file, the TG 02 indicates the playing of the other ones of a WAV file and a MIDI file and the TG 03 indicates a pause of playing, whereas the infrared receiving indicates the faster playing speed when value 1 is received and plays a specific audio file when value 2 is received.

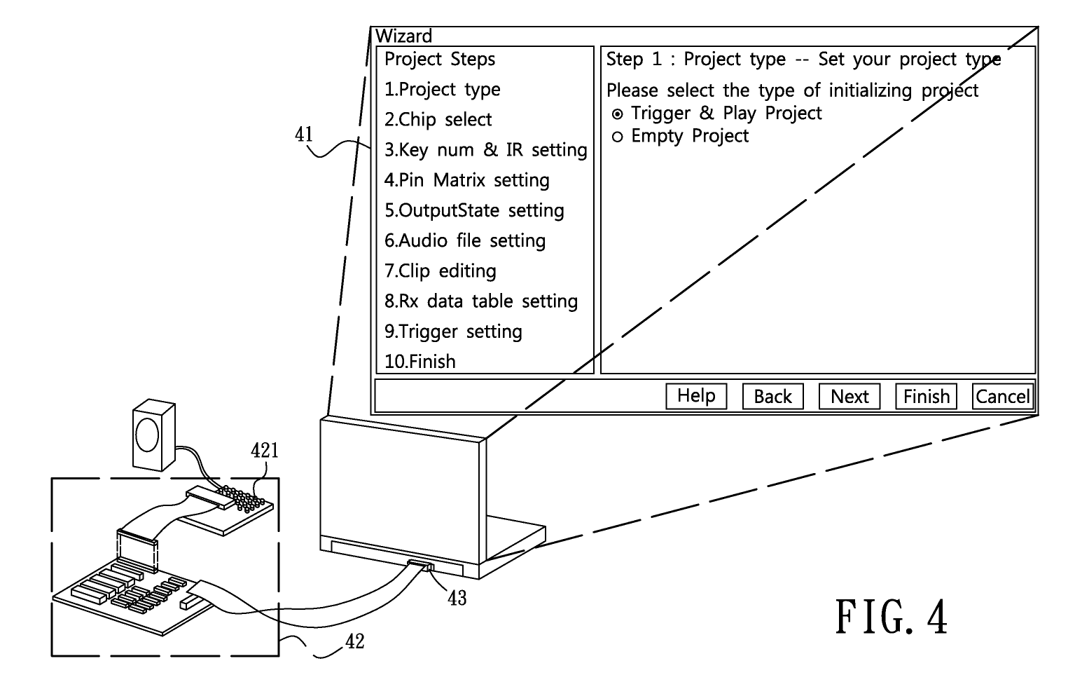

With referring to FIG. 4, the present speech IC simulation system 4 has a visualized development system of speech IC 41 for generating a firmware code corresponding to a speech IC project and a circuit emulator 42 for receiving the firmware code outputted through an output port and emulating the speech IC project. The visualized development system of speech IC 41 further includes a wizard interface for establishing and compiling the speech IC project and generating the firmware code, a visualized allocation interface for setting and displaying a visualized in-circuit emulator allocation interactively corresponding to the speech IC project and a visualized clip editing and event setting interface for setting and performing clips and the corresponsive system trigger events. The circuit emulator 42 may have a memory (not shown) for re-writable and recording the firmware code and a verification module 421 for simulating the speech IC project. In other words, the firmware code generated form the visualized development system of speech IC 41 is outputted from an output port 43 and uploaded to the circuit emulator 42 for executing and debugging. The verification module 421 may equip the LED light, key pad and speaker to show the execution result responsive to the trigger submit by the user directly.

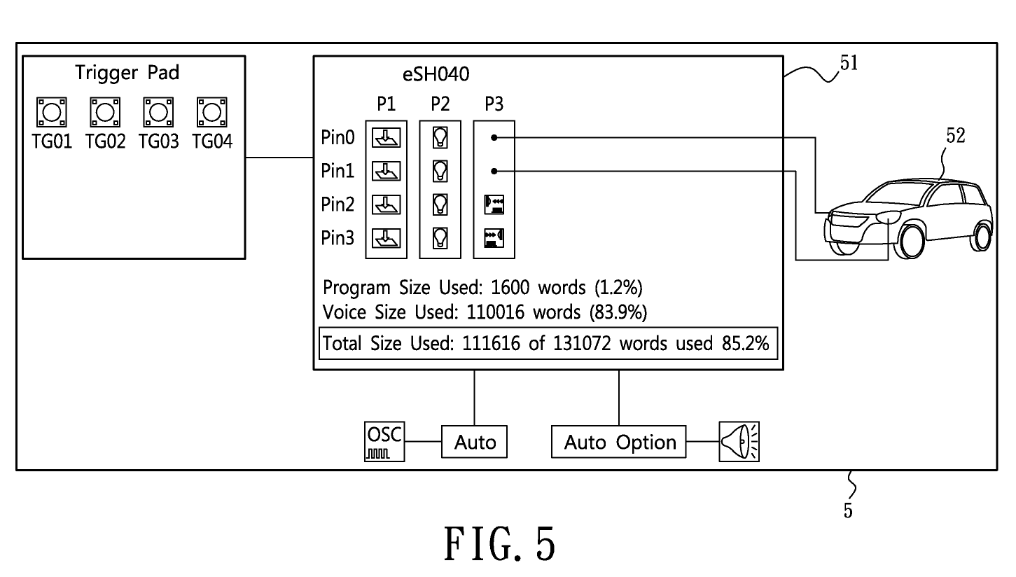

With referring to FIG. 5, the speech IC simulation system 5 has a visualized development system of speech IC 51 for establishing a speech IC project and setting and performing clips and system trigger events, and a product icon 52 corresponding to the speech IC project for displaying a simulation result according to the performing of the clips and the system trigger events. The visualized development system of speech IC 51 includes a wizard interface for establishing the speech IC project, a visualized allocation interface for setting and displaying a visualized in-circuit emulator allocation interactively corresponding to the speech IC project and a visualized clip editing and event setting interface for setting and performing the clips and the system trigger events. As shown in FIG. 5, the product icon 52 is a toy car icon corresponding to the speech IC project of a toy car, and it shows the simulation result responsive to the performing of the visualized allocation interface and the clips and the system trigger events. For instance, the speech IC simulation system 5 executes the corresponsive clips for instructing a speaker to play an audio file when the TG 01 is pushed and instructing a LED light of input/output port P2 to glitter when the input/output pin is assigned a LED icon. Thus the simulation may be performed without any in-circuit emulator.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A speech IC simulation method, comprising:
establishing and compiling a speech IC project in a wizard interface;
setting and displaying a visualized in-circuit emulator (ICE) allocation interactively corresponding to the speech IC project in a visualized allocation interface; and
setting and performing a clip and a corresponsive system trigger event in a visualized clip editing and event setting interface.

2. The method of claim 1, wherein the step of setting the ICE allocation includes the step of setting a visualized trigger pad displaying at least a trigger icon and a visualized system allocation.

3. The method of claim 2, further comprising:
setting amount of the trigger icon of the visualized trigger pad and function of each trigger icon in the visualized allocation interface; and
setting amount of input/output port, function of input/output port, output pin and memory status of the visualized system allocation.

4. The method of claim 1, further comprising:
operating an oscillator icon for setting an oscillator type and an output icon for setting an audio output type in the visualized allocation interface.

5. The method of claim 1, wherein the step of establishing and compiling the speech IC project in the wizard interface further comprises the steps of:
selecting a project type to be generated;
selecting an IC type;
setting amount of a trigger icon and an infrared transmission status;
setting a pin matrix;
setting a function and a signal type of each port and pin, wherein the function is preset as triggers, and as outputs otherwise;
setting an audio file;
editing a clip for adding the function and instruction to be performed;
setting a received data table;
setting a corresponsive trigger type of each trigger; and
selecting a finish item to show related information of the speech IC project.

6. The method of claim 5, wherein the project type to be generated comprises a trigger and play project and an empty project, and the trigger and play project controls audio play and pause by trigger.

7. The method of claim 5, further comprising:
selecting an end item after selecting the finish item for compiling the speech IC project.

8. The method of claim 5, wherein the IC type comprising a single channel IC and a multiple channel IC.

9. The method of claim 8, wherein the visualized clip editing and event setting interface provides a multiple channel play icon for setting an audio type to be played simultaneously if the multiple channel IC is selected.

10. The method of claim 5, further comprising:
adjusting the IC type automatically according to a change of amount of the trigger icon; and
displaying the ICE allocation interactively corresponding to the speech IC type changed in the visualized allocation interface.

11. A firmware code generation method of speech IC, comprising:
establishing and compiling a speech IC project in a wizard interface for generating a firmware code of speech IC, wherein a modification of the speech IC project further comprises the steps of: setting and displaying a visualized in-circuit emulator (ICE) allocation interactively corresponding to the speech IC project in a visualized allocation interface, and setting and performing a clip and a corresponsive system trigger event at least in a visualized clip editing and event setting interface.

12. The method of claim 11, further comprising:
outputting the firmware code of speech IC to a memory.

13. The method of claim 11, wherein the step of establishing and compiling the speech IC project in the wizard interface further comprises the steps of:
selecting a project type to be generated;
selecting an IC type;
setting amount of a trigger icon and an infrared transmission status;
setting a pin matrix;
setting a function and a signal type of each port and pin, wherein the function is preset as triggers, and as outputs otherwise;
setting an audio file;
editing a clip for adding the function and instruction to be performed;
setting a received data table;
setting a corresponsive trigger type of each trigger; and
selecting a finish item to show related information of the speech IC project.

14. A computer readable medium storing a visualized development system of speech IC, wherein the visualized development system of speech IC comprises:
a wizard interface for establishing a speech IC project;
a visualized allocation interface for setting and displaying a visualized in-circuit emulator (ICE) allocation interactively corresponding to the speech IC project; and
a visualized clip editing and event setting interface for setting and performing a clip and a corresponsive system trigger event.

15. The medium of claim 14, wherein the visualized in-circuit emulator allocation comprises a visualized trigger pad displaying at least a trigger icon and a visualized system allocation.

16. The medium of claim 15, wherein the visualized allocation interface sets amount of the trigger icon of the visualized trigger pad and function of each trigger icon in the visualized allocation interface and amount of input/output port, function of input/output port, output pin and memory status of the visualized system allocation.

17. The medium of claim 16, wherein the visualized allocation interface further adjusts an IC type automatically according to a change of amount of the trigger icon and displays the visualized in-circuit emulator allocation interactively corresponding to the speech IC type changed.

18. The medium of claim 14, wherein the visualized allocation interface further comprises:
an oscillator icon for setting an oscillator type; and
an output icon for setting an audio output type.

19. The medium of claim 14, wherein the wizard interface further comprising a project establishing step selection window, an advanced selection window and a control trigger window.

20. The medium of claim 14, wherein the speech IC project further comprising a trigger and play project controlling audio play and pause by trigger and an empty project.

21. The medium of claim 14, wherein the visualized clip editing and event setting interface further comprises:
an icon toolbox window with a plurality of function icons for selecting; and
at least a clip setting window for forming the selected function icons into at least a clip to be performed.

22. The medium of claim 21, wherein the visualized clip editing and event setting interface further comprises an event setting window for setting a system trigger event.

23. The medium of claim 22, wherein the clip and the system trigger event are capable of linkage and adjustment interactively, and the system trigger event drives the clip to be performed of a trigger icon.

24. A speech IC simulation system, comprising:
a visualized development system of speech IC for generating a firmware code corresponding to a speech IC project; and
a circuit emulator for receiving the firmware code outputted through an output port and emulating the speech IC project.

25. The system of claim 24, wherein the visualized development system of speech IC at least comprises a wizard interface for establishing and compiling the speech IC project and generating the firmware code.

26. The system of claim 25, wherein the visualized development system of speech IC further comprises:
a visualized allocation interface for setting and displaying a visualized in-circuit emulator (ICE) allocation interactively corresponding to the speech IC project; and
a visualized clip editing and event setting interface for setting and performing at least a clip and a corresponsive system trigger event.

27. The system of claim 24, wherein the circuit emulator at least comprises:
a memory for re-writable and recording the firmware code; and
a verification module for simulating the speech IC project.

28. The system of claim 24, wherein the output port is a printer port or an USB port.

29. A speech IC simulation system, comprising:
a visualized development system of speech IC for establishing a speech IC project and setting and performing a clip and a system trigger event; and
a product icon corresponding to the speech IC project for displaying a simulation result according to the performing of the clip and the system trigger event.

30. The system of claim 29, wherein the visualized development system of speech IC further comprises:
a wizard interface for establishing the speech IC project;
a visualized allocation interface for setting and displaying a visualized in-circuit emulator (ICE) allocation interactively corresponding to the speech IC project; and
a visualized clip editing and event setting interface for setting and performing the clip and the system trigger event.
